(19) United States
(12) Patent Application Publication
(10) Pub. No.: US 2021/0131102 A1
(43) Pub. Date: May 6, 2021

(54) METHOD FOR THE PRODUCTION OF THERMAL BARRIER BLOCKS

(71) Applicant: GEOLYTH MINERAL TECHNOLOGIE GMBH, Traun (AT)

(72) Inventor: Karl ENZENHOFER, St. Peter/AU (AT)

(73) Assignee: GEOLYTH MINERAL TECHNOLOGIE GMBH, Traun (AT)

(21) Appl. No.: 16/753,479

(22) PCT Filed: Oct. 4, 2018
(86) PCT No.: PCT/AT2018/060232

§ 371 Date: Apr. 3, 2020

(30) Foreign Application Priority Data
Oct. 6, 2017 (AT) A50860/2017

(51) Int. Cl. E04C 1/41; B28B 11/04; E04B 2/26

(52) U.S. Cl. CPC E04C 1/41; E04B 2/26; B28B 11/043

(57) ABSTRACT

The invention relates to perforated building blocks (1) which are filled with thermal insulation material (2), as well as a method and a system for the production thereof.

### CROSS-REFERENCE TO RELATED APPLICATIONS

The present application is a national phase application of PCT Application No. PCT/AT2018/060232, filed Oct. 4, 2018, entitled “METHOD FOR PRODUCING THERMAL BARRIER BLOCKS”, which claims the benefit of Austrian Patent Application No. A50860/2017, filed Oct. 6, 2017, each of which is incorporated by reference in its entirety.

### BACKGROUND OF THE INVENTION

### 1. Field of the Invention

The invention relates to perforated building blocks filled with insulation material, in particular to vertically perforated bricks, and to a method and a system for the production thereof.

### 2. Description of the Related Art

Perforated building blocks are to be understood here as building materials which have at least one opening that is open on one side or one through-opening. Typical perforated building blocks are hollow blocks, perforated bricks or vertically perforated bricks.

Perforated building blocks in the form of vertically perforated bricks filled with insulation material which are filled with plastic foams, are known from the prior art. They are either introduced into the openings of the block in liquid form and expanded and solidified there, or finished plastics are cut to size and pressed into the openings. Plastics as insulation material are disadvantageous due to their diffusion resistance and problematic disposal.

Furthermore, it is known to introduce mineral foams as insulation into the openings in perforated building blocks and to allow them to cure therein. They are complex to produce because good heat-insulating mineral foams must cure quickly and curing or adhering in the system can be a problem.

It is also known to introduce blown insulation materials with plastics as binders into the openings in perforated building blocks, where the perforated building blocks are problematic in terms of disposal and especially during recycling due to the plastic content.

DE 2614512 A1 describes a hollow block which is filled with loose, small-sized foam bodies and the openings of which, which are open on one side, are closed with a cover. A pumice concrete mix capable of setting is introduced into the openings to produce the cover. The process of filling and closing the cavities is not continuous. The disadvantage is the use of foam as insulation material.

DE 3122087 A1 describes a hollow block which is filled with mineral fibers and the openings of which are closed with a closure. An adhesive, gypsum slurry, or cement slurry is used to make the closure. The settable pumice cement mix can be introduced into the openings. The process of filling and closing the cavities is not continuous. It is disadvantageous to use fibers as insulation material, since these are problematic to handle or when they emerge after damage to or the cutting of hollow blocks.

DE 1784364 A1 describes a hollow block which is filled with mineral fibers and the openings of which are closed with a cover. To produce the cover, a flowable plastic or a plastic granulate which is subsequently melted, or cement mortar is introduced into the openings. It is disadvantageous to use fibers as insulation material, since these are problematic to handle or when they emerge after damage to or the cutting of hollow blocks.

DE 19917670 A1 describes a chimney element brick, in the cavity of which lightweight concrete can be cast. For cavities that are open on one side, it is described that a loose bed of expanded glass granulate can be used. The top opening is closed by spraying on a cement slurry. It is disadvantageous that the cover is formed by a cement slurry since flowable, curable material tends to accumulate on system parts, such as nozzles or the mixers required for mixing the cement slurry, especially when the system comes to a standstill. A disadvantage is the loose fill made of expanded glass granulate which would trickle out of the chimney brick if damaged or cut.

DE 102015013405 A1 describes the filling of a brick with a fluid, curable, in particular foamed, filling material. An additional cover is not formed. The introduction of a liquid material has the disadvantage that it takes longer to dry out due to the large amount of liquid contained therein. In addition, liquid curable material tends to accumulate on parts of the system or the mixers required, especially when the system is at a standstill.

EP 0049348 A1 describes the filling of a brick with a solid mortar which can contain a foamed or expanded mineral additive. An additional cover is not formed.

### SUMMARY OF THE INVENTION

The object on which the invention is based is to create a perforated brick filled with thermal insulation material which is simple to manufacture and suitable for use on construction sites and, if desired, the thermal insulation material can be purely biological or purely mineral, i.e., without plastics.

This object of the invention is achieved by a perforated building block, a method for producing a perforated building block, and by a system for producing a perforated building block.

According to the invention, a perforated building block is proposed which is filled with a thermal insulation material. At least one opening of the perforated building block is filled with thermal insulation material and which is also provided on at least one side thereof with a covering layer which is formed from a cured setting material. The thermal insulation material is introduced into the openings in a moist, pourable state. The covering layer is subsequently formed in a second step after the filling with thermal insulation material. The material applied to form the covering layer differs from the thermal insulation material.

In the method for producing a perforated building block according to the invention, thermal insulation material is filled into at least one opening of the perforated building block. Subsequently, the opening is provided with a covering layer on at least one side thereof by applying a setting material in a free-flowing state which is subsequently brought to setting by applying liquid. The covering layer is subsequently formed in a second step after the filling with thermal insulation material. The material applied to form the covering layer differs from the thermal insulation material.

According to the invention, the system for the production of perforated building blocks which are filled with thermal insulation material comprises:

a transport device on which at least one row of perforated building blocks can be placed next to one another, wherein this row is continuously transportable through the system with the transport device;

an introduction device with which free-flowing thermal insulation material is introduced into the openings of the perforated building blocks continuously transported by the transport device; and

a device for applying setting material which applies setting material to the thermal insulation material present in the openings of the perforated building blocks continuously transported by the transport device.

The covering layer is subsequently formed in a second step after the filling with thermal insulation material. The material applied to form the covering layer differs from the thermal insulation material.

In the present invention, the openings of the perforated building blocks are filled with a free-flowing material forming the insulation material, the openings through which the material was introduced subsequently are closed with a material that cures to form a covering layer. If the openings are through holes, they can be closed on one or both sides by a material that cures to form a covering layer.

The covering layer prevents the filled material from coming out of the opening again. In addition, the covering layer can preferably be formed from a material that is more abrasion-resistant and/or pressure-resistant than the insulation material.

In the case of through holes, the side from which the free-flowing material was introduced from above is preferably closed first, the perforated building block is subsequently turned and then the other side is closed.

The material curing to form a covering layer is preferably cement or another mineral binder or a mineral building material mixture containing a binder.

Free-flowing material is to be understood as a material that is suitable for filling the openings of the perforated building blocks without being introduced in liquid form and without being pressed into the openings with plungers, pistons or slides that move in a perpendicular manner to the perforated building block. Free-flowing bulk material is to be understood in particular as dry to moist bulk material. The moist bulk material is present in such a way that it does not form clumping masses that adhere to one another, or only forms such after compression. This behavior can best be illustrated with a snowball, because the free-flowing snowflakes only become a clumping mass that clings together after compression.

The free-flowing material is preferably an expanded granulate. The free-flowing material preferably includes hollow microspheres, in particular closed-cell hollow microspheres.

The free-flowing material particularly preferably includes perlite, in particular closed-cell perlite, that is to say perlite in the form of hollow microspheres.

The expanded granules, in particular the hollow microspheres or the closed-cell perlite, preferably have a grain size of 0.01 to 0.8 mm.

The hollow microspheres, in particular the closed-cell perlite hollow spheres, are preferably produced under thermal treatment, the surface of which remains closed during the expansion process.

A particularly preferred material for use as the thermal insulation material of the present invention is available from GEOLYTH Mineral Technologie GmbH under the name GEOLYTH Perlit (hollow microsphere) P100.

The free-flowing material is preferably introduced into the perforated building block as expanded granules in a mixture with a mineral binder or with a mineral formulation which is suitable for forming a self-curing mass on contact with water. The free-flowing material is particularly preferably moistened before introduction. The mineral binder is preferably in the form of a powder.

The free-flowing material which is in the form of expanded granules in a mixture with a mineral binder, is particularly preferably moistened before introduction, the moist mixture still being free-flowing and the mineral binder curing only after the mixture has been compressed. This effect can be explained by the fact that in the moistened mixture the constituents of the mineral binder are separated from each other by the granules of the expanded granulate and the low moisture is not sufficient to allow them to cure. When the mixture is compressed, the constituents of the mineral binder and the water contained in the mixture are compressed more tightly so that it sets. As a result, the binder adheres to the perforated building block on the one hand and binds the granules of the expanded granulate on the other hand.

As a result, the perforated building block can be cut or drilled in the finished state without the insulation material trickling out of the perforated building block. The covering layer is advantageous in this case if it is harder and/or more abrasion-resistant than the insulation material and/or sets faster, so that the finished perforated building block can be handled more quickly.

A formulation comprising a mineral binder based on a sulphate-aluminate cement and a porous bulk material, preferably in the form of hollow microspheres, particularly preferably in the form of expanded perlite (hollow microspheres), is preferably used as the thermal insulation material. The mineral binder is preferably present in the formulation in a proportion selected from a range of from 10 parts by weight to 70 parts by weight. The sulphate-aluminate cement is preferably contained in the mineral binder in a proportion selected from a range of from 55 parts by weight to 85 parts by weight. The microspheres or the expanded perlite (as a hollow microsphere) are preferably closed-celled, a vacuum being present inside the approximately spherical hollow bodies of the closed-cell expanded perlite particles or the hollow microsphere.

The hollow microspheres and/or the closed-cell expanded perlite (as hollow microspheres) are preferably contained in the formulation in a proportion selected from a range of from 20 parts by weight to 75 parts by weight.

A particularly preferred mineral formulation for use as the thermal insulation material of the present invention is described in EP 2902375 B1 and is available under the name GEOLYTH Bluesmart® composite from GEOLYTH Mineral Technologie GmbH.

The present invention comprises a perforated building block which is filled with a thermal insulation material comprising heat-insulating particles (in particular heat-insulating hollow particles such as hollow spheres) and binders (in particular powdered mineral binders), at least one opening of the perforated building block being filled with this thermal insulation material and the opening also being provided at least on one side thereof with a covering layer on the thermal insulation material which is formed from a cured setting material. The curing setting material which is used for the covering layer can be identical to the binder of the thermal insulation material, whereby this can be applied entirely without the heat-insulating particles, or at least with fewer heat-insulating particles. The thermal insulation material and the curing setting material can also differ in the water or moisture content with which they are applied.

The thermal insulation material is preferably a bulk material. The thermal insulation material preferably comprises closed-cell hollow microspheres.

The thermal insulation material is preferably closed-cell perlite (as a hollow microsphere) or closed-cell perlite (as a hollow microsphere) in a mixture with a binder, preferably a mineral binder.

The thermal insulation material is preferably mineral.

The covering layer is preferably formed from a mineral material which is cured after contact with liquid.

The perforated building block is preferably made of mineral material.

An improvement over the prior art is also a perforated building block which is filled with a thermal insulation material comprising heat-insulating particles (especially heat-insulating hollow particles such as hollow spheres) and binders (especially powdery mineral binders), the heat-insulating particles and the binder in a mixture as a free-flowing mixture material is present which is moistened before being introduced, the moist mixture still being free-flowing, and the thermal insulation material curing to a coherent mass only after the mixture has been compressed in the at least one opening in the perforated building block. The binder (preferably mineral binder, in particular cement) is preferably in a finer grain than the thermal insulation particles (preferably hollow particles, hollow spheres, hollow microspheres, closed-cell mineral hollow spheres, expanded perlite or closed-cell expanded perlite). The volume fraction of the heat-insulating particles in the mixture is preferably higher than the volume fraction of the binder. The moist mixture of heat-insulating particles and the binder is not liquid or flowable. The moist mixture of heat-insulating particles and the binder does not cure to a coherent mass without compression, but remains free-flowing. The mixture is preferably introduced into openings of the perforated building block that are open on both sides and compressed from both sides, preferably at different times. Preferably, at least one free space resulting from the compression in the opening is subsequently filled with additional material which preferably differs from the thermal insulation material in terms of composition or moisture content. Said free space is preferably filled using the method according to the invention with a setting material to form a cover or a covering layer. The thermal insulation material and the setting material preferably differ with respect to at least one property selected from the group of properties comprising: presence of heat-insulating particles; proportion of heat-insulating particles; water content; presence of a binder; material of the binder; proportion of the binder. The setting material of the covering layer preferably has a lower proportion of heat-insulating particles and a higher proportion of binder.

The setting material of the covering layer preferably cures to a coherent mass without compression.

The present invention comprises a method for producing a perforated building block which is filled with a thermal insulation material, a thermal insulation material being filled in at least one opening of the perforated building block in a first step and the opening being provided with a covering layer on at least one side thereof in a next step, by applying a setting material in a free-flowing state which is only subsequently set.

The perforated building blocks are preferably filled by introducing thermal insulation material in the form of a bulk material or a free-flowing material into the openings.

The thermal insulation material is preferably introduced into the openings in a moist state.

The thermal insulation material is preferably compressed in the openings after filling.

The setting material is preferably applied to the thermal insulation material in a dry state and liquid is subsequently applied to the setting material so that it cures.

The present invention comprises a system for the production of perforated building blocks which are filled with thermal insulation material, at least comprising:

a transport device on which at least one row of perforated building blocks can be placed so that this row can be transported through the system by the transport device;

an introduction device with which thermal insulation material is introduced into the openings of the perforated building blocks; and

a device for applying setting material which applies setting material to the thermal insulation material present in the openings of the perforated building blocks.

The introduction device is preferably fed with the thermal insulation material by a continuous mixer. The thermal insulation material is preferably moistened in a mixer, preferably in a continuous mixer. The thermal insulation material preferably comprises heat-insulating particles and a binder and can already be present upstream of the mixer as a mixture of heat-insulating particles and a binder, or the two components can be mixed in the mixer, preferably before the water is supplied for moistening. The thermal insulation material is fed from the mixer to the introduction device in the free-flowing state.

The system preferably comprises at least one stripping element which is attached downstream of the device for introducing the thermal insulation material and upstream of the device for applying the setting material and which strips excess thermal insulation material from the top of the perforated building blocks.

Downstream of the introduction device or downstream of the stripping element and upstream of the device for applying the setting material, the system preferably comprises at least one compacting device which compresses the thermal insulation material in the openings of the perforated building blocks.

Downstream of the device for applying the setting material, the system preferably comprises a stripping element which strips excess material from the top of the perforated building blocks.

Downstream of the device for applying the setting material or downstream of the subsequent stripping element, the system preferably comprises a compacting device which presses setting material into the openings of the perforated building blocks.

Downstream of the device for applying the setting material or downstream of the subsequent stripping element or downstream of the following compacting device, the system preferably comprises a device for applying liquid to the setting material.

The system preferably includes a turning device downstream of the system components described up to this point.

The system preferably includes, downstream of the turning device, a further transport device and a further device for applying the setting material which applies setting material from the second side of the perforated building blocks on the thermal insulation material present in the openings of the perforated building blocks, in particular perforated bricks.

Following the turning device, the system preferably comprises at least these devices:

a first compacting device which compresses the thermal insulation material in the openings of the perforated building blocks;

the device for applying the setting material;

a stripping element which strips off excess material from the top of the perforated building blocks; and

a second compacting device which presses setting material into the openings of the perforated building blocks; a device for applying liquid to the setting material.

### BRIEF DESCRIPTION OF THE DRAWINGS

Preferred embodiment variants according to the invention are illustrated by way of example with reference to the drawings and are in no case limiting:

FIG. 1: Shows a first variant of an exemplary perforated building block according to the invention in a sectional view from the side.

FIG. 2: Shows a second variant of an exemplary perforated building block according to the invention in a sectional view from the side.

FIG. 3: Shows schematically the preferred manufacturing method according to the invention of the covering layer on the perforated building block filled with insulation material.

FIG. 4: Shows schematically the preferred manufacturing method according to the invention of the covering layer on the second side of a perforated building block filled with insulation material.

FIG. 5: Shows schematically the preferred manufacturing method according to the invention of a thermal insulation brick according to the invention with the preferred system according to the invention in a side view.

FIG. 6: Shows schematically the preferred manufacturing method according to the invention of a thermal insulation brick according to the invention with the preferred system according to the invention in a view from above.

### DETAILED DESCRIPTION

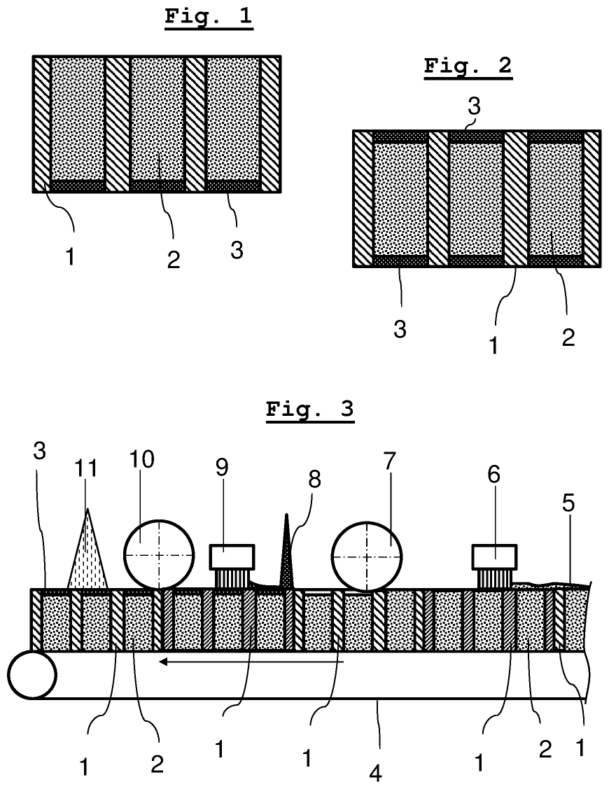

FIG. 1 shows a perforated building block 1 according to the invention in the form of a vertically perforated brick which is filled with insulation material 2, the openings of the perforated building block 1 being closed on one side with a covering layer 3. During transport and handling, the covering layer 3 preferably points downwards, so that no insulation material 2 can get down out of the perforated building block 1.

FIG. 2 shows a perforated building block 1 according to the invention in the form of a vertically perforated brick which is filled with insulation material 2, the openings of the perforated building block 1 being closed on both sides with a covering layer 3.

As can be seen in FIGS. 1 and 2, the covering layers 3 are preferably present within the openings of the perforated building block 1 so that the material of the covering layers 3 does not protrude above the bottom or top of the perforated building block 1.

FIG. 3 illustrates the preferred manufacturing method of the covering layers 3 and the thermal insulation brick according to the invention. The filling and sealing process is preferably carried out continuously, the perforated building blocks 1 being moved through the device in a row (abutting one another) by a transport device 4, in particular a conveyor belt. In the first step, the openings of the perforated building block 1 are filled with free-flowing material 5 which forms the insulation material 2 (this step is shown in FIG. 5).

As can be seen on the far right in FIG. 3, excess free-flowing material 5 which is located on the outside of the perforated building block 1, can be stripped off with a first stripping element 6, for example a strip, a rubber lip or a brush, the excess free-flowing material 5 is pushed into possibly incompletely filled openings, or is pushed sideways from the perforated building blocks 1.

After the first step, the free-flowing material 5 can be compressed in the openings, preferably by rolling a first roller 7 made of elastic material, preferably rubber, on the top of the perforated building blocks 1.

In the second step, a setting material 8, preferably in the dry state, is applied to the top of the perforated building blocks 1.

After the second step, excess setting material 8 can be removed from the top of the perforated building blocks 1 with a second stripping element 9.

After the second step, the setting material 8 can be compressed in the openings, for example by a second roller 10 made of elastic material, preferably rubber, rolling on the top of the perforated building blocks 1.

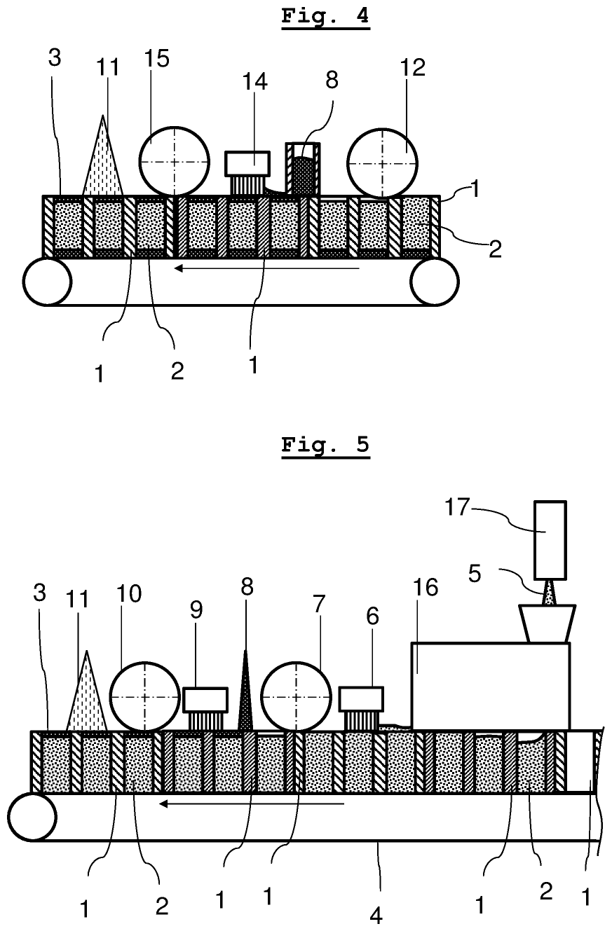

If the setting material 8 has been applied in the dry state, as is preferred, this is sprayed with liquid 11 in the third step, the setting material 8 cures after contact with the liquid 11 to form the covering layer 3. The setting material is preferably cement which is sprayed with water. The application of the setting material 8 in the dry state has the advantage that excess dry setting material 8 can simply be wiped away without it adhering to and curing on surfaces. In addition, the device for applying the setting material 8 is not contaminated and/or blocked by curing material which would require regular cleaning. The setting material 8 can in particular be sprayed on or sprinkled on. It is also possible to have a container which is open at the bottom and is present in the width of the bricks and is at least approximately close thereto and is filled with the setting material 8, as illustrated in FIG. 4.

The stripping and/or pressing of the free-flowing material 5 and/or the setting material 8 means that the top of the perforated building blocks 1 remains at least largely free of material 5, 8 which is advantageous when installing the perforated building blocks 1.

Subsequently, the perforated building blocks 1 can be turned (not shown) and, as shown in FIG. 4, the already sealed side can be moved downward through a further sealing system. The free-flowing material 5 can first be compressed from the second side, for example again with an elastic roller or third roller 13. Then, a setting material 8, preferably in the dry state, is applied to the top of the second side of the perforated building blocks 1.

After this step, excess setting material 8 can be removed from the top of the perforated building blocks 1 with a third stripping element 14.

After this step, the setting material 8 can be compacted in the openings, for example by a fourth roller 15 made of elastic material, preferably rubber, rolling on the top of the perforated building blocks 1.

If the setting material 8 has been applied in the dry state, it is sprayed with liquid 11 in the next step, and the setting material 8 cures after contact with the liquid 11 to form the covering layer 3. The setting material 8 is preferably cement which is sprayed with water.

FIG. 5 shows the system according to the invention with the introduction device 16 and material supply 17 of the free-flowing material 5. The perforated building blocks 1 are placed on the right of the introduction device 16 on the transport device 4, the introduction device 16 having a width such that all openings of the perforated building blocks 1 located below can be filled with free-flowing material 5. The introduction device 16 is supplied with the free-flowing material 5 via a material feed 17, for example from the outlet end of a mixer which mixes the free-flowing material 5 from several components and/or treats the free-flowing material 5 with moisture, preferably with water. The mixer is preferably a continuous flow mixer which can continuously supply the pouring device with free-flowing material 5. In any case, a continuous mixer is more suitable for the present process in question than a batch mixer.

Alternatively, the free-flowing material 5 can come directly from a storage container and can be transported into the introduction device 16 without further processing.

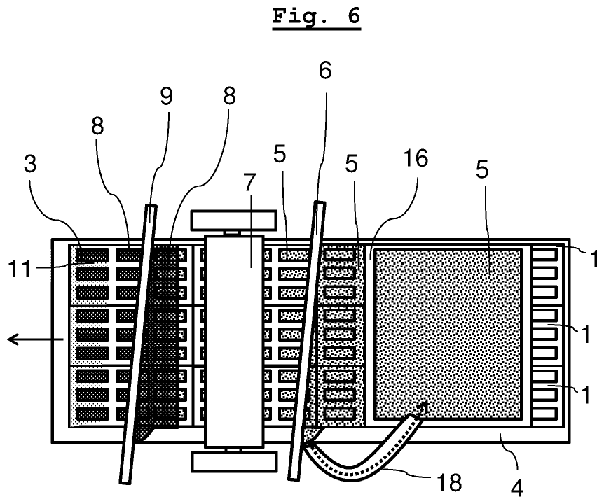

As shown in FIGS. 5 and 6, the introduction device 16 preferably comprises a container which is open at the bottom towards the perforated building blocks 1 and which is stationary just above the perforated building blocks 1 passing therethrough, so that free-flowing material 5 from the container arrives into the openings of the perforated building blocks 1, wherein movable means for regular distribution of the free-flowing material 5 can be provided in the container. Because the container is just above the perforated building blocks 1 and corresponds to the width thereof, only a small part of the free-flowing material 5 reaches the conveyor device laterally and through the gap between the front end of the container and the perforated building blocks 1. In this case, a plurality of perforated building blocks 1 can also be placed parallel to one another on the transport device 4 so that they are simultaneously supplied with free-flowing material 5, as illustrated in FIG. 6.

Material that comes laterally from the introduction device 16 onto the transport device 4 and/or is stripped from the top of the perforated building blocks 1 by the stripping element 5 is preferably fed back into the container by a return transport device 18 and thus directly reused, preferably without preparation, for filling the perforated building blocks 1. The return transport can be realised, for example, by suction or a return conveyor belt.

The same could of course also be implemented for the setting material 8, so that the stripped setting material 8 is fed back to the application device therefor.

As illustrated in FIGS. 5 and 6, the entire filling and sealing process takes place continuously, the perforated building blocks 1 being conveyed by the transport device 4 at a constant speed and without intermediate stops. It is particularly advantageous that no handling devices or work stations need to be moved in the transport direction with the perforated building blocks 1, which results in a simple and energy-saving plant construction, since constant acceleration and braking of transport devices or work stations can be omitted.

The present filling system and/or the present sealing system can be connected or integrated into a production system of perforated building blocks 1, in particular hollow perforated bricks, in that the production line of the production system runs through the present system as a transport device 4, or the transport device 4 is connected to the production line. The production line preferably has a switch element so that a partial quantity of the perforated building blocks 1 produced can be filled by the system according to the invention and a different partial quantity can be produced as unfilled perforated building blocks 1.

However, the present system can also be used as a stand-alone or offline system which preferably has loading and unloading robots which are preferably used to place perforated building blocks 1 in front of the introduction device 16 on the transport device 4 and to lift from the transport device 4 after the last sealing process. The perforated building blocks 1 can be lifted off the production line of a production system and, after filling and sealing, can also be placed there again. The unfilled perforated building blocks 1 can also be delivered on pallets, whereby it is always conceivable to simultaneously lift an entire layer of perforated building blocks 1 from the pallet and place them on the transport device 4. After the last sealing has taken place, the heat-insulating bricks which are produced can advantageously be removed from the transport device 4 and immediately placed on pallets and transported away for storage or to the place of use. This is possible since a fast-curing setting material 8 is preferably used which obtains the necessary strength particularly quickly due to the rather small layer thickness of the covering layer 3.

Since the free-flowing material 5 is introduced in a dry to moist state and in any case not as a liquid, the heat insulating bricks do not require any or hardly any time to dry out sufficiently, so that these could be installed immediately after production. Autoclaving or other heating of the manufactured thermal insulation bricks can be avoided in any case.

Since the filling and sealing of the perforated building blocks 1 can take place at room temperature, no cooling of the manufactured thermal insulation bricks is necessary.

1-26. (canceled)

27. A perforated building block, comprising:
at least one opening of the perforated building block filled with thermal insulation material, the thermal insulation material being introduced in a moist, free-flowing state into the at least one opening; and
at least one side of said at least one opening provided with a covering layer formed from a cured setting material.

28. The perforated building block according to claim 27, wherein the thermal insulation material comprises closed hollow microspheres or closed-cell perlite in the form of hollow microspheres.

29. The perforated building block according to claim 27, wherein the thermal insulation material comprises heat-insulating particles and a binder.

30. The perforated building block according to claim 29, wherein:
the heat-insulating particles are enclosed in the set binder so that the thermal insulation material in the perforated building block is not free-flowing;
the moist thermal insulation material being compressed in the perforated building block to enclose the heat-insulating particles in the binder;
the moist thermal insulation material being such that without compressing the moist thermal insulation material, the heat-insulating particles are not enclosed in the binder during drying and remain free-flowing.

31. The perforated building block according to claim 30, wherein the material of the covering layer is introduced into free space in the opening of the perforated building block resulting from compressing the moist thermal insulation material.

32. The perforated building block according to claim 27, wherein the covering layer is formed from a mineral material which is cured after contact with liquid, the mineral material being applied in a free-flowing state and being set by subsequent application of liquid.

33. The perforated building block according to claim 27, wherein the covering layer and the thermal insulation material are formed from formulations which differ in at least one property selected from the group of properties comprising: presence of heat-insulating particles;
proportion of heat-insulating particles; water content; presence of a binder; material of the binder; and proportion of the binder.

34. A method for producing a perforated building block which is filled with a thermal insulation material, comprising the steps:
filling the thermal insulation material in at least one opening of the perforated building block; and
providing said opening on at least one side thereof with a covering layer by applying a setting material in a free-flowing state and subsequently applying a liquid to set said setting material.

35. The method according to claim 34, wherein the thermal insulation material being introduced into the openings in the form of a free-flowing material.

36. The method according to claim 34, wherein the thermal insulation material is introduced into the openings in a moist state.

37. The method according to claim 34, wherein the thermal insulation material is compressed after filling in the openings.

38. The method according to claim 34, wherein the setting material is applied in a dry state to the thermal insulation material and liquid is subsequently applied to the setting material so that it cures.

39. A system for the production of perforated building blocks which are filled with thermal insulation material, comprising:
a transport device on which at least one row of perforated building blocks can be placed next to one another, the transport device continuously transporting this row through the system;
an introduction device with which free-flowing thermal insulation material is introduced into openings of the perforated building blocks while they are continuously transported by the transport device; and
a device for applying setting material which device applies setting material to the thermal insulation material present in the openings of the perforated building blocks while they are continuously transported by the transport device.

40. The system according to claim 39, wherein the thermal insulation material is moistened before being introduced by the introduction device, the thermal insulation material comprising heat-insulating particles and binders.

41. The system according to claim 39, wherein a stripping element which is attached downstream of the introduction device and upstream of the device for applying the setting material strips excess thermal insulation material from the top the perforated building blocks.

42. The system according to claim 39, wherein a compacting device is attached downstream of the introduction device or downstream of a stripping element and upstream of the device for applying setting material, which compacting device compresses the thermal insulation material in the openings of the perforated building blocks.

43. The system according to claim 39, wherein downstream of the device for applying setting material there is a stripping element which strips excess setting material from the top of the perforated building blocks.

44. The system according to claim 39, wherein downstream of the device for applying setting material there is a device for applying liquid to the setting material.

45. The system according to claim 39, wherein the system comprises a turning device following the transport device and the system comprises a further transport device downstream of the turning device and a further device for applying setting material which applies setting material from the second side of the perforated building blocks to the thermal insulation material present in the openings of the perforated building blocks.

46. The system according to claim 45, wherein the system comprises at least these devices following the turning device:
a first compacting device which compresses the thermal insulation material in the openings of the perforated building blocks;
a device for applying setting material;
a stripper element which strips excess material from the top of the perforated building blocks;
a second compacting device which presses setting material into the openings of the perforated building blocks; and
a device for applying liquid to the setting material.
